(19) United States
(12) Patent Application Publication
(10) Pub. No.: US 2008/0314104 A1
(43) Pub. Date: Dec. 25, 2008

(54) Lock cylinder structure

(75) Inventor: Ping-Hung Hsieh, Gangshan Town (TW)

Correspondence Address: TROXELL LAW OFFICE PLLC, SUITE 1404, 5205 LEESBURG PIKE, FALLS CHURCH, VA, 22041, US

(73) Assignee: Taiwan Fu Hsing Industrial Co., Ltd.

(21) Appl. No.: 11/812,974

(22) Filed: Jun. 22, 2007

(51) Int. Cl. E05B 27/04

(52) U.S. Cl. 70/493

(57) ABSTRACT

A lock cylinder structure mainly comprises a cylinder shell, a plug and a pin group. The cylinder shell has a housing and the plug is rotatably positioned within the housing of the cylinder shell. The plug has at least one first lower pin hole and at least one second lower pin hole having a circular-cylindrical inside wall and a stopper portion formed at the circular-cylindrical inside wall. The pin group comprises at least one first lower pin and at least one second lower pin, the first lower pin is slideably positioned in the first lower pin hole of the plug and has a first end, and the second lower pin is slideably positioned in the second lower pin hole and has a tube body and a cover. The tube body has a limit protrusion and a second end, and the cover is adaptably coupled to the tube body. The limit protrusion is blocked at the stopper portion of the second lower pin hole and there is a height difference between the second end of the tube body and the first end of the first lower pin.

### FIELD OF THE INVENTION

The present invention relates generally to a lock cylinder, more particularly to a lock cylinder structure with hollow lower pin that may enhance antitheft ability.

### BACKGROUND OF THE INVENTION

The well-known lock cylinder structure mainly comprises a cylinder shell, a plug and a pin group. The cylinder shell and the plug mostly dispose pins, wherein the cylinder shell disposes a plurality of upper pins with a same height and the plug disposes a plurality of lower pins with different heights. The plug, by means of arrangement of the upper and lower pins, is limited by the upper and lower pins not to rotate in the cylinder shell to achieve limiting and anti-rotating functionalities. If attempt to unlock a lock, an authorized key needs to be inserted into the plug, in which the authorized key has bits having diverse heights corresponding to the lower pins having diverse heights in the plug. When the authorized key is inserted into the plug, the upper surface of each lower pin of the plug is approximately aligned with the interface between the cylinder shell and the plug allowing the plug to rotate in the cylinder shell without limited by the upper pins and the lower pins. However, when thief attempts to illegally unlock a lock device, he still can insert an unauthorized key into keyway of the plug and provides a beat on the lock opportunely, i.e., the lower pins in the plug are hit by the bits of the unauthorized key to simultaneously hit the upper pins between the cylinder shell and the plug, which makes the upper pins move to the cylinder shell, and then the plug may be opportunely turned by applying the unauthorized key to unlock easily, accordingly, the lock cannot provide effective ability on antitheft and security in a locked condition. Besides, the known lower pins are manufactured almost in solid causing a high cost in material resulting in high cost for entire lock manufacture as well.

### SUMMARY OF THE INVENTION

The primary object of the present invention is to provide a lock cylinder structure comprising a cylinder shell, a plug and a pin group. The plug has at least one first lower pin hole and at least one second lower pin hole, in which the second lower pin hole has a circular-cylindrical inside wall and a stopper portion formed at the circular-cylindrical inside wall. The pin group comprises at least one first lower pin and at least one second lower pin, in which the first lower pin is slideably positioned in the first lower pin hole of the plug and has a first end, the second lower pin is slideably positioned in the second lower pin hole of the plug and has a tube body and a cover. The tube body has a limit protrusion and a second end and the cover is adaptably coupled to the tube body. The limit protrusion is blocked at the stopper portion of the second lower pin hole to form a height difference between the second end of the tube body and the first end of the first lower pin. When thief inserts an unauthorized key into a keyway of the plug, since bits of the unauthorized key cannot contact the second lower pin due to the height difference, the lock cylinder structure is widely improved on antitheft and security to prevent unlocking by inserting an unauthorized key into the plug and opportunely providing a beat on the lock. Moreover, the second lower pin of the present invention is manufactured in hollow able to decrease material cost for manufacturing the second lower pin.

A lock cylinder structure according to the present invention comprises a cylinder shell having a housing, a plug rotatably positioned within the housing of the cylinder shell and a pin group. The plug has at least one first lower pin hole and at least one second lower pin hole, wherein the second lower pin hole has a circular-cylindrical inside wall and a stopper portion formed at the circular-cylindrical inside wall. The pin group comprises at least one first lower pin and at least one second lower pin, in which the first lower pin is slideably positioned in the first lower pin hole of the plug and has a first end, the second lower pin is slideably positioned in the second lower pin hole of the plug and has a tube body and a cover being adaptably coupled to the tube body. The tube body has a hollow inner space, a limit protrusion and a second end. The limit protrusion is blocked at the stopper portion of the second lower pin hole, wherein there is a height difference between the first end of the first lower pin and the second end of the tube body of the second lower pin.

A lower pin structure according to the present invention, for being slideably positioned in at least one lower pin hole of a plug, comprises a tube body having a hollow inner space, a circumferential surface, a limit protrusion and an end and a cover being adaptably coupled to the tube body.

A lock cylinder structure according to the present invention comprises a cylinder shell having a housing, a plug rotatably positioned within the housing of the cylinder shell and a pin group. The plug has at least one first lower pin hole, at least one second lower pin hole having a circular-cylindrical inside wall and a stopper portion formed at the circular-cylindrical inside wall and a keyway, wherein the keyway further has a keyway flange. The pin group comprises at least one first lower pin and at least one second lower pin, in which the first lower pin is slideably positioned in the first lower pin hole of the plug and has a first end contacting the keyway flange of the keyway. The second lower pin is slideably positioned in the second lower pin hole of the plug and has a limit protrusion and a second end, in which the limit protrusion is blocked at the stopper portion of the second lower pin hole to form an interval between the second end and the keyway flange of the keyway.

### DESCRIPTION OF THE DRAWINGS

FIG. 1 is an exploded perspective view of a lock cylinder structure according to a preferred embodiment of the present invention.

FIG. 2 is a perspective view of the lock cylinder structure assembly according to a preferred embodiment of the present invention.

FIG. 3 is a partially sectioned view of the lock cylinder structure taken along line A-A of FIG. 2.

FIG. 4 is an exploded perspective view of a lower pin according to a preferred embodiment of the present invention.

FIG. 5 is a sectioned view of the lock cylinder structure assembly taken along line B-B of FIG. 2.

FIG. 6 is an exploded perspective view of a lower pin according to another embodiment of the present invention.

FIG. 7 is a sectioned view of the lock cylinder structure assembly according to another embodiment of the present invention.

FIG. 8 is an exploded perspective view of a lower pin according to a further embodiment of the present invention.

FIG. 9 is a sectioned view of the lock cylinder structure assembly according to a further embodiment of the present invention.

FIG. 10 is an exploded perspective view of a lower pin according to a yet another embodiment of the present invention.

FIG. 11 is a sectioned view of the lock cylinder structure assembly according to a yet another embodiment of the present invention.

FIG. 12 is a sectioned side view of the lock cylinder structure taken along line C-C of FIG. 2.

FIG. 13 is a motion diagram showing an unauthorized key is inserted into the lock cylinder structure according to an embodiment of the present invention.

FIG. 14 is a motion diagram showing an authorized key is inserted into the lock cylinder structure according to another embodiment of the present invention.

### DETAILED DESCRIPTION OF THE INVENTION

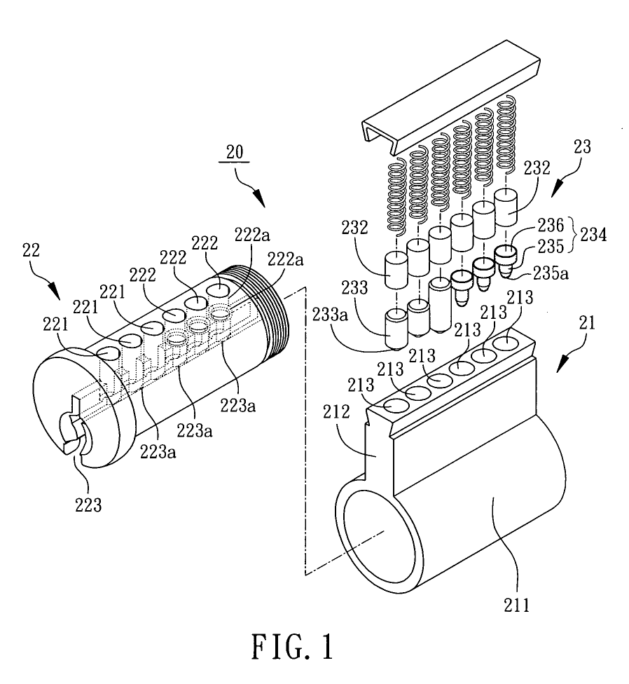

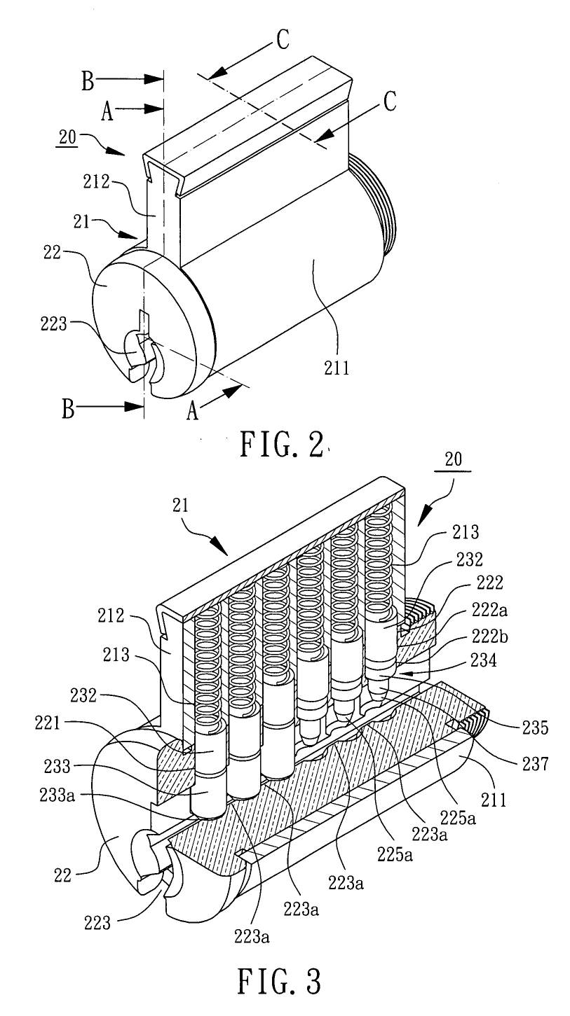

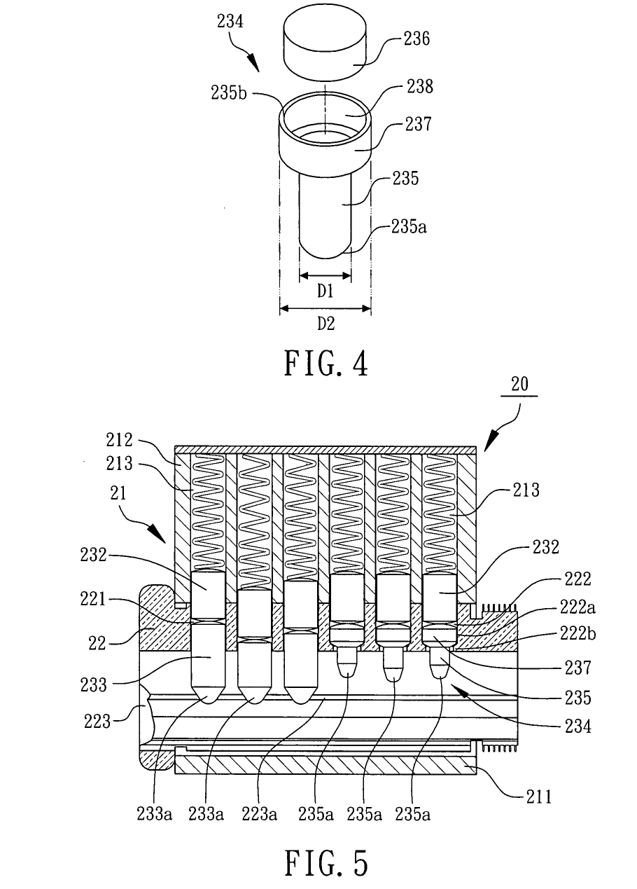

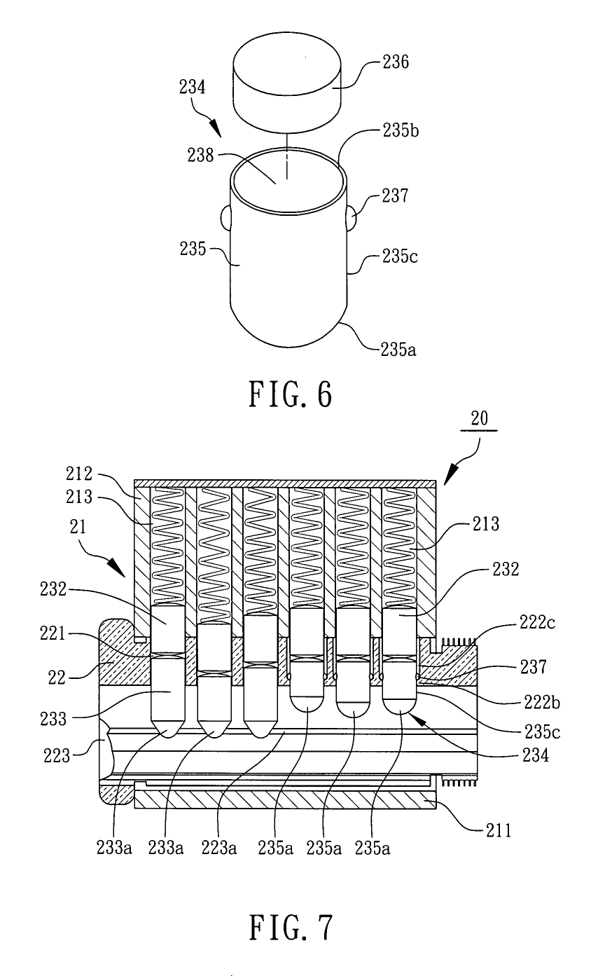

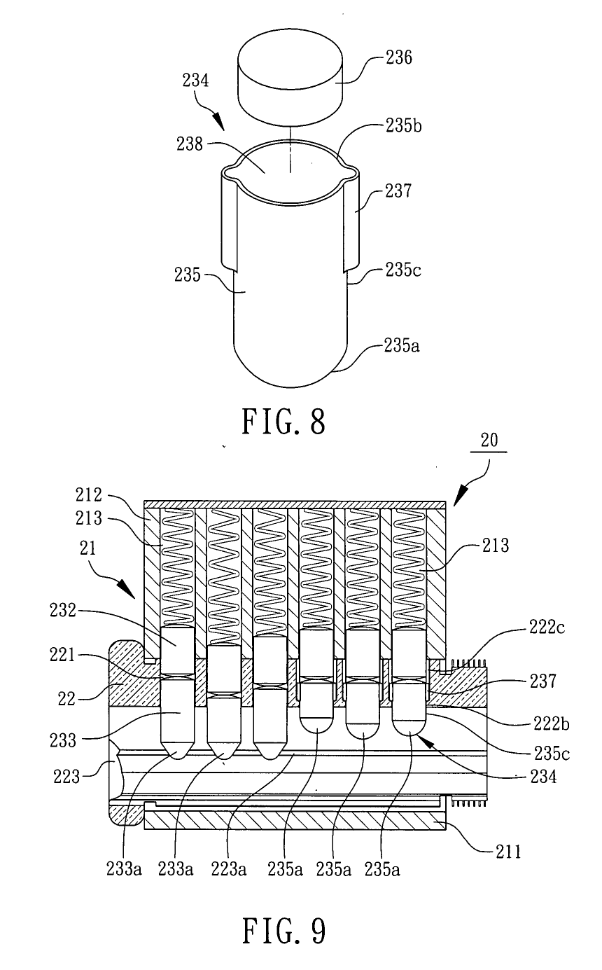

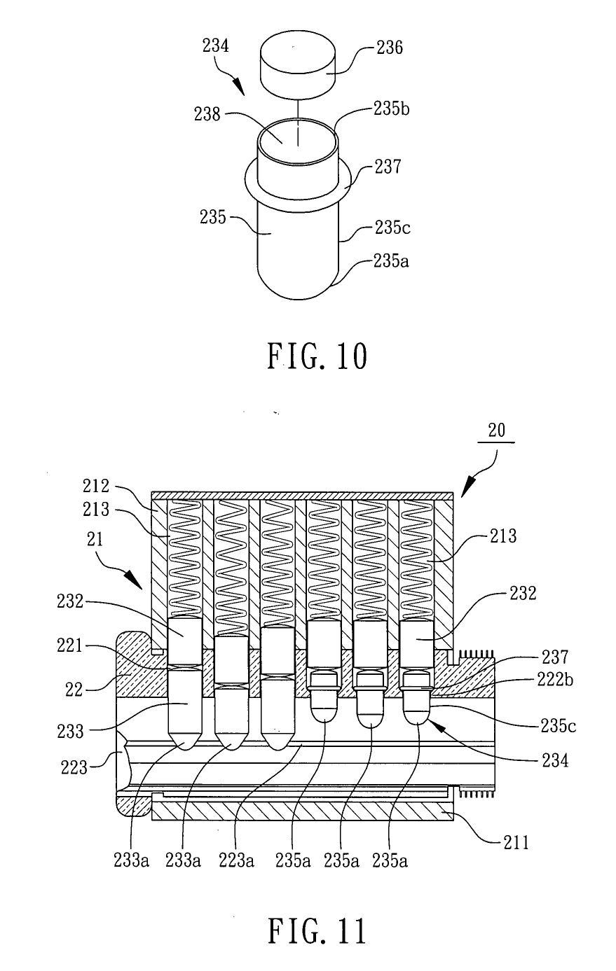

Referring to FIGS. 1, 2 and 3, a lock cylinder structure 20 according to a preferred embodiment of the present invention comprises a cylinder shell 21, a plug 22 and a pin group 23, wherein the cylinder shell 21 may be in various shapes. In this embodiment, the cylinder shell 21 has a housing 211 and an extending protrusion 212 extended radially from the periphery of the housing 211, in which the extending protrusion 212 has a plurality of upper pin holes 213, and the upper pin holes 213 are communicated with the housing 211. The plug 22 is rotatably positioned within the housing 211 of the cylinder shell 21 and has at least one first lower pin hole 221, at least one second lower pin hole 222 and a keyway 223, wherein the keyway 223 communicates with the first lower pin hole 221 and the second lower pin hole 222. When the plug 22 is not rotated, the first lower pin hole 221 and the second lower pin hole 222 are corresponding to the upper pin holes 213 of the extending protrusion 212. The second lower pin hole 222 has a circular-cylindrical inside wall 222a and a stopper portion 222b formed at the circular-cylindrical inside wall 222a, preferably the stopper portion 222b protrudes from the circular-cylindrical inside wall 222a. The keyway 223 has a keyway flange 223a and the pin group 23 comprises a plurality of upper pins 232, at least one first lower pin 233 and at least one second lower pin 234. The upper pins 232 are disposed in the upper pin holes 213 of the extending protrusion 212. The first lower pin 233 is slideably positioned in the first lower pin hole 221 of the plug 22 and has a first end 233a. In this embodiment, when a key does not insert the keyway 223 of the plug 22, the first end 233a of the first lower pin 233 should contacts the keyway flange 223a of the keyway 223. The second lower pin 234, slideably positioned in the second lower pin hole 222 of the plug 22, in this embodiment as shown in FIGS. 1, 4 and 5, has a shape of T and comprises a tube body 235 and a cover 236 being adaptably coupled to the tube body 235. In this embodiment, the second lower pin 234 is formed by assembling the tube body 235 and the cover 236. The tube body 235 has a second end 235a, an opening 235b, a first outer diameter D1, a limit protrusion 237 and a hollow inner space 238, and the cover 236 fills into the tube body 235 through the opening 235b. In this embodiment, the limit protrusion 237, formed at one end of the tube body 235 opposite to the second end 235a, has a second outer diameter D2 larger than the first outer diameter D1 of the tube body 235. The cover 236 is disposed at the hollow inner space 238 of the tube body 235 allowing the second lower pin 222 to form a hollow shell in shape of T, preferably the cover 236 is in shape of pillar or flat pin. Otherwise, in another embodiment as shown in FIGS. 6, 7, 8 and 9, the tube body 235 has a circumferential surface 235c, and the limit protrusion 237 protrudes from the circumferential surface 235c of the tube body 235. Moreover, the second lower pin hole 222 further has a sliding groove 222c recessed from the circular-cylindrical inside wall 222a, herein the stopper portion 222b of the second lower pin hole 222 is located beneath the sliding groove 222c. It is preferable that the limit protrusion of the tube body 235 is movable to be disposed at the sliding groove 222c of the second lower pin hole 222 so as to prevent the second lower pin 234 from rotating and that the limit protrusion 237 is disposed around the circumferential surface 235c of the tube body 235 as shown in FIGS. 10 and 11. In this embodiment as shown in FIG. 4, the tube body 235 is formed by stamping and deep drawing a metal plate, otherwise in another embodiment, the tube body 235 is integrally formed with the cover 236 in which they are formed by stamping and bending a metal plate. Besides, in this embodiment as shown in FIG. 4, the second lower pin 234 is manufactured in hollow so that material cost of the second lower pin 234 can be widely reduced.

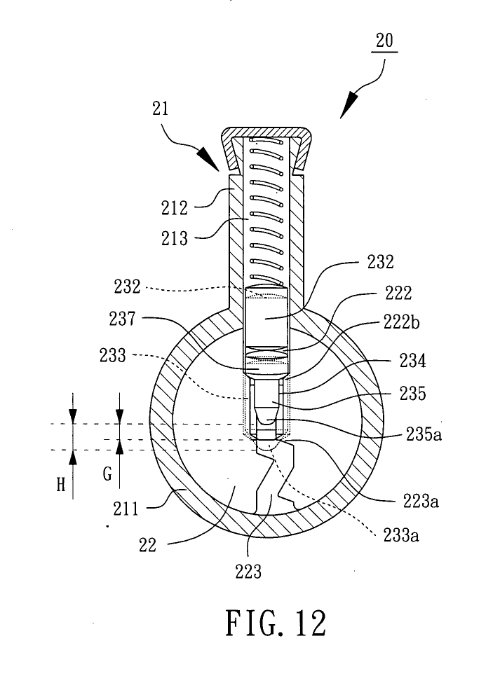

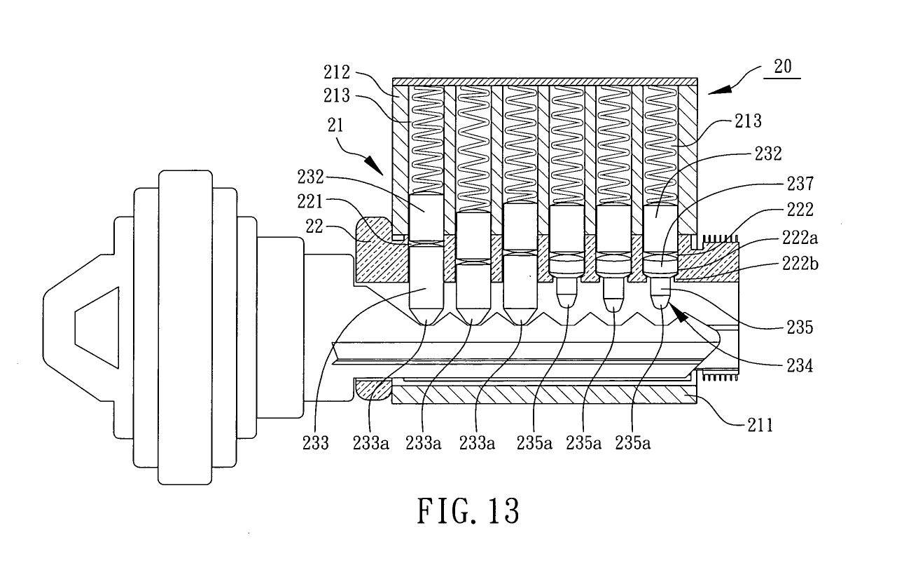

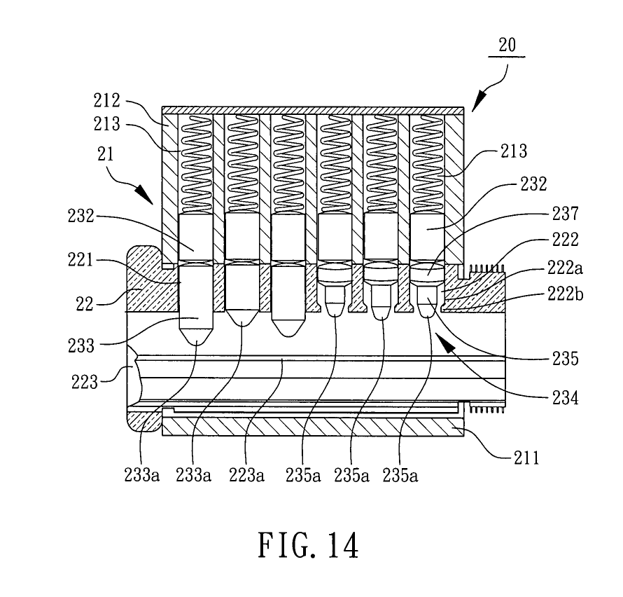

In this embodiment as shown in FIGS. 5 and 12, when the lock cylinder structure 20 is not inserted by a key, the first end 233a of the first lower pin 233 contacts the keyway flange 223a of the keyway 223 as well as that there is a height difference H between the second end 235a of the tube body 235 and the first end 233a of the first lower pin 233, since the limit protrusion 237 of the tube body 235 is blocked at the stopper portion 222b of the second lower pin hole 222. Besides, there is also an interval G between the second end 235a of the tube body 235 and the keyway flange 223a of the keyway 223. When a thief inserts an unauthorized key into the keyway 223 as shown in FIGS. 12 and 13, the bits of the unauthorized key is unable to contact the second lower pin 234 because of the height difference H or the interval G, so that it can prevent the thief from unlocking through inserting the unauthorized key into the plug 22 and opportunely providing a beat on the lock, thereby substantially enhancing antitheft and security. On the contrary, referring to FIG. 14, when an authorized key (not shown in the drawing) is inserted into the keyway 223 of the plug 22, because the bits depth of the authorized key corresponds to the heights of the first lower pin 233 and the second lower pin 234, the plug 22 can rotate along the unlocking interface to unlock smoothly as the authorized key is turned.

While the present invention has been particularly illustrated and described in detail with respect to the preferred embodiments thereof, it will be clearly understood by those skilled in the art that various changed in form and details may be made without departing from the spirit and scope of the present invention.

What is claimed is:

1. A lock cylinder structure comprising:
a cylinder shell having a housing;
a plug rotatably positioned within the housing of the cylinder shell and having at least one first lower pin hole and at least one second lower pin hole formed therein, wherein the second lower pin hole having a circular-cylindrical inside wall and a stopper portion formed at the circular-cylindrical inside wall;
at least one first lower pin being slideably positioned in the first lower pin hole of the plug and having a first end; and
at least one second lower pin being slideably positioned in the second lower pin hole of the plug and having a tube body and a cover being adaptably coupled to the tube body, wherein the tube body has a hollow inner space, a limit protrusion and a second end, the limit protrusion is blocked at the stopper portion of the second lower pin hole, wherein there is a height difference between the first end of the first lower pin and the second end of the tube body of the second lower pin.

2. The lock cylinder structure according to claim 1, wherein the cylinder shell includes an extending protrusion extending radially from the periphery of the housing, the extending protrusion further has a plurality of upper pin holes that are communicated with the housing.

3. The lock cylinder structure according to claim 2, wherein the first lower pin hole and the second lower pin hole of the plug are corresponding to the upper pin holes of the extending protrusion.

4. The lock cylinder structure according to claim 2, further comprises a plurality of upper pins that are disposed in the upper pin holes of the extending protrusion.

5. The lock cylinder structure according to claim 1, wherein the plug has a keyway having a keyway flange, the first end of the first lower pin contacts the keyway flange.

6. The lock cylinder structure according to claim 5, wherein there is an interval between the second end of the tube body of the second lower pin and the keyway flange of the keyway.

7. The lock cylinder structure according to claim 1, wherein the tube body has a circumferential surface, the limit protrusion protrudes from the circumferential surface.

8. The lock cylinder structure according to claim 7, wherein the limit protrusion is disposed around the circumferential surface.

9. The lock cylinder structure according to claim 7, wherein the second lower pin hole has a sliding groove recessed from the circular-cylindrical inside wall, the stopper portion is located beneath the sliding groove and the limit protrusion of the tube body is movable to be disposed at the sliding groove.

10. The lock cylinder structure according to claim 7, wherein the second lower pin has a shape of T and the limit protrusion is formed at one end of the tube body opposite to the second end.

11. The lock cylinder structure according to claim 1, wherein the second lower pin has a shape of T.

12. The lock cylinder structure according to claim 1, wherein the tube body further has an opening and the cover fills into the tube body through the opening.

13. The lock cylinder structure according to claim 1, wherein the tube body is integrally formed with the cover.

14. The lock cylinder structure according to claim 13, wherein the tube body and the cover is formed by stamping method.

15. The lock cylinder structure according to claim 1, wherein the stopper portion of the second lower pin hole protrudes from the circular-cylindrical inside wall.

16. A low pin structure for being slideably positioned in at least one lower pin hole of a plug comprising a tube body having a hollow inner space, a circumferential surface, a limit protrusion and an end and a cover being adaptably coupled to the tube body.

17. The lower pin structure according to claim 16, wherein the limit protrusion is disposed around the circumferential surface.

18. The lower pin structure according to claim 16, wherein it has a shape of T.

19. The lower pin structure according to claim 16, wherein the tube body further has an opening, the cover fills into the tube body through the opening.

20. The lower pin structure according to claim 16, wherein the tube body is integrally formed with the cover.
